(19) United States
(12) Patent Application Publication
(10) Pub. No.: US 2017/0114964 A1
(43) Pub. Date: Apr. 27, 2017

(54) MULTI-DIRECTIONAL FLASHLIGHT

(71) Applicant: Ronnie Pritchett, Ramona, CA (US)

(72) Inventor: Ronnie Pritchett, Ramona, CA (US)

(21) Appl. No.: 15/397,703

(22) Filed: Jan. 3, 2017

Related U.S. Application Data
(63) Continuation of application No. 13/473,173, filed on May 16, 2012, now Pat. No. 9,534,750.

(51) Int. Cl. F21L 4/02; H05B 33/08; F21V 23/04; F21V 23/02; F21V 5/00; F21V 7/00

(52) U.S. Cl. CPC F21L 4/022; F21V 5/006; F21V 7/0075; F21V 7/0083; F21V 23/0414; F21V 23/02; H05B 33/0806; H05B 33/0845; F21Y 2101/00

(57) ABSTRACT

There is provided a hand held flashlight having different intensity and direction of projected light controlled by switches which function independently or pently.

### REFERENCE TO RELATED PATENT APPLICATION

This patent application is a continuation of and claims priority to U.S. patent application Ser. No. 13/473,173, filed May 16, 2012, now U.S. Pat. No. 9,534,750, issued Jan. 3, 2017, which application is herein incorporated by reference in its entirety.

### FIELD

The present invention relates to a hand held flashlight having a different direction and intensity of projected light. More particular, there is provided a flashlight which comprises multidirectional and intensity stationary light emitting source.

### BACKGROUND

Traditional flashlights are normally provided with a reflector having rotational symmetry. That is, the reflector has a shaped formed by rotating a generatrix along the longitudinal axis passing through the bulb of the flashlight.

U.S. Pat. No. 7,387,402 discloses a multiple lens LED flashlight which provides one or more wide angle projections of light as well as a concentrated light beam. Sets of LEDs are mounted to separate circuit boards.

U.S. Pat. No. 5,630,661 discloses a flashlight utilizing halogen lamps having variable fields of illumination with adjustably positioned lens.

### SUMMARY

According to the invention there is provided a flashlight comprising at least three light emitting bulbs within reflectors which direct light either to the sides or to the front where the light can also be emitted in at least 180 degrees. A dimmer switch for each bulb is provided whereby the light intensity is controlled for each bulb depending upon a direction required to be used.

It is therefore a general object of the invention to provide a flashlight which has multiple directions of light emission and intensity.

It is a further object of the invention to provide a flashlight which emits light to one or two sides.

It is another object of the invention to provide a flashlight with reflectors that captures and redirects light in a preselected beam.

These and other objects and advantages will become apparent from a reading of the preferred embodiments together with the drawings.

### BRIEF DESCRIPTION OF THE DRAWINGS

FIG. 1 is a top elevation in cross-section of the flashlight of the invention.

FIG. 2 is a circuit diagram wherein a dimmer controls all three bulbs in the invention.

FIG. 3 is a circuit diagram wherein each bulb is controlled by a dimmer switch.

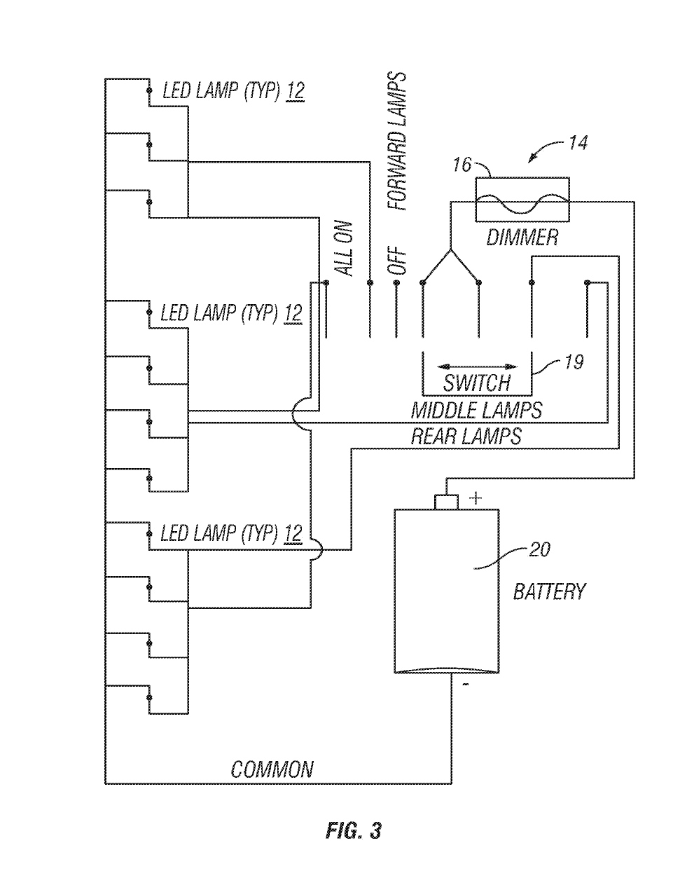

### DESCRIPTION

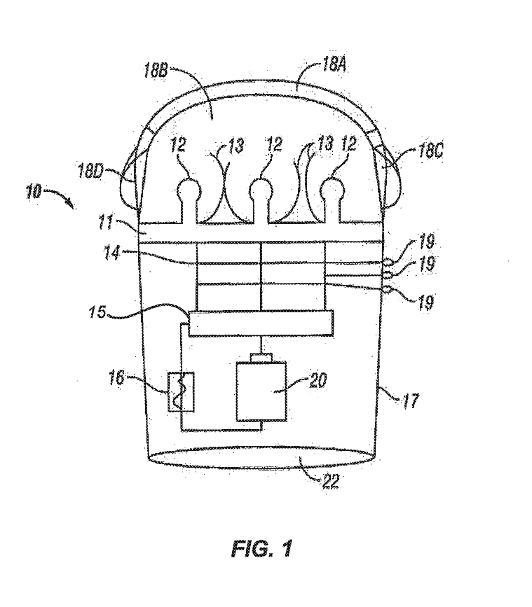

With reference to FIG. 1 there is provided a flashlight (10) comprising a tubular housing (21) made of any suitable material, such as but not limited to plastic or aluminum. The illustrated elongated housing extends between a large end (18) and a small removable end or cover (22).

At the large end (18) is a transparent cover (18A) defining a chamber (18B) sized and configured to receive a bulb housing (11) which contains at least three light emitting bulbs (12) which can have an incandescent filament or preferably light emitting diodes (LEDs). The LEDs can have any size, shape and color. The bulbs (12) are each housed in reflectors (13). The reflectors (13) extend upwardly around the bulbs (12) to form a socket for the bulbs (12). The two side reflectors direct light to the sides and the middle reflector (13) directs light to the front so that the light is emitted when all three bulbs (12) are activated and the light is emitted at least 180 degrees. The reflectors (13) may be in the shape of a paraboloid or other similar shape to capture and redirect light from a bulb in a preselected beam.

The bulb housing (11) may be removable to provide access to the battery (20).

The bulbs (12) may be at an angle with respect to the reflector (13) or the reflector may be shaped to capture substantially all the light produced by the bulb and redirect it toward a direction in a predetermined pattern.

The reflector is made typically from a plastic material which is coated on at least one surface with a light-reflecting material such as silver, aluminum or other similar material.

A standard electronic ballast (15) is provided for converting battery voltage from the battery through a dimmer switch (16) to the bulbs (12). Alternatively there is provided a dimmer switch for each of the bulbs (12) so that the intensity of light emitted can vary with each bulb.

Electrical circuitry (14) is provided for connecting the electronic ballast (15) to the bulbs (12) and the ballast to the electrical contact with the battery. The circuitry delivers electrical energy from the power source through the dimmer switch(es) to the light generating assembly. The circuitry in combination with the ballast delivers electrical energy from the power source to the light generating assembly. The circuitry (14) includes on and off switch(es) for controlling the flow of electricity from the battery to the ballast. External electrical input jacks (not shown) may be provided to effect recharging of the battery.

External switches (19) are provided for each of the bulbs.

As seen in FIG. 1 the circuitry (14) can be provided with a single dimmer switch (16) which controls the intensity of light emitted from all the bulbs (12). Also there are external switches (19) which activate or deactivate the bulbs (12).

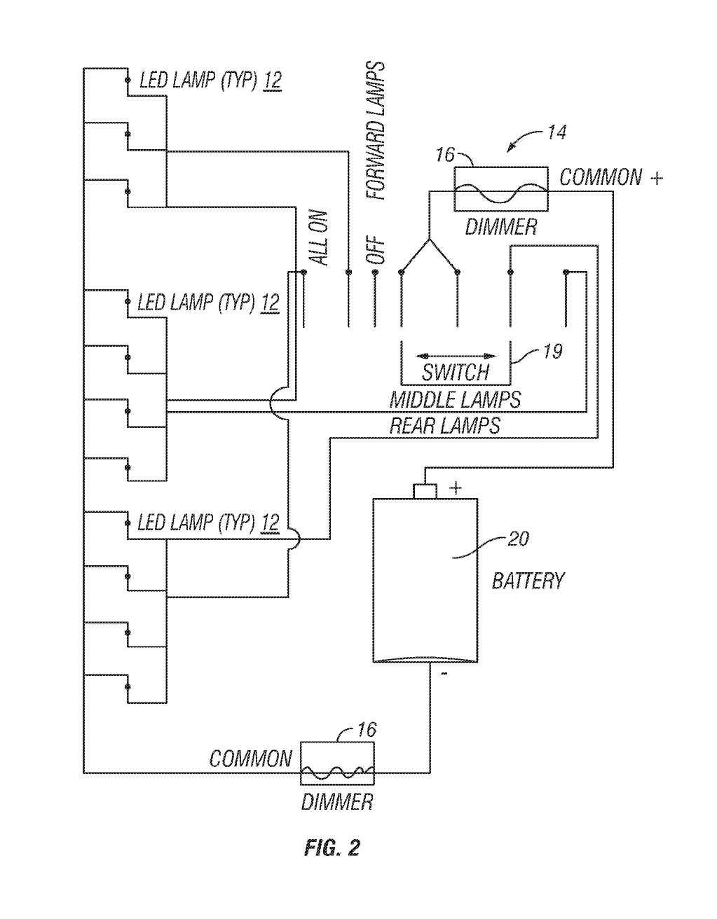

As shown in FIG. 2, the circuitry (14) comprises a dimmer switch (16) that controls the intensity of the electricity to each bulb so as to vary the degree of light intensity to each of the bulbs (12). This allows either side bulbs to be activated for viewing only the sides without light diffused from the center bulb which may interfere with sight.

The lens (18A) may comprise convex existing lens which act with the reflectors to form a concentrated light beam to each side and front of the flashlight.

Although the present invention has been described in terms of certain embodiments, other embodiments apparent to those of ordinary skill in the art also are within the scope of this invention. Thus, various changes and modifications may be made without departing from the spirit and scope of the invention. For instance, various components may be repositioned as desired. Moreover, not all of the features, aspects and advantages are necessarily required to practice the present invention. Accordingly, the scope of the present invention is intended to be defined only by the claims that follow.

What is claimed is:

1. A flashlight having a variable field of illumination comprising an elongated tubular housing and a multiple bulb housing, and a transparent cover, said tubular housing defining a chamber sized and configured to receive at least one battery, the bulb housing comprises said cover and a lower shell member that are secured together, a bulb assembly is positioned in a region between the outer shell member and the lower shell member, said bulb assembly comprising at least three light emitting bulbs each housed within a reflector whereby one reflector directs light to one side of the bulb housing, another reflector directs light to the other side of the bulb housing, and another reflector directs light to the front of the housing so that light can be emitted at least 180 degrees, an electronic ballast for converting battery voltage to a voltage required to operate said lamps, electrical circuitry for electrically connecting said electronic ballast to said lamps and electrical contact to said battery, said circuitry including a dimmer switch for each of said bulbs and a switch to activate said bulbs.

2. The flashlight of claim 1 wherein said bulbs are LEDs.

3. The flashlight of claim 1 wherein said bulbs are with an incandescent filament.

4. The flashlight of claim 1 wherein the dimmer switch controls the intensity of light transmission of at least one bulb.

5. The flashlight of claim 1 wherein said reflectors inhibit the vertical diffusion of light.

6. The flashlight of claim 1 wherein each bulb is provided with a dimmer switch which is independent of other dimmer switches.

7. The flashlight of claim 1 wherein said transparent cover comprises a convex configuration.

8. The flashlight of claim 7 where said transparent cover comprises convex portions at its sides to concentrate light from the reflectors toward the sides.
